(19) United States
(12) Patent Application Publication
(10) Pub. No.: US 2025/0042158 A1
(43) Pub. Date: Feb. 6, 2025

(54) LIQUID SUPPLY APPARATUS AND LIQUID DISCHARGE APPARATUS

(71) Applicant: CANON KABUSHIKI KAISHA, Tokyo (JP)

(72) Inventors: TAKUMA NAKAMURA, Tokyo (JP); KICHINOSUKE HIROKAWA, Tokyo (JP); HIROMASA YONEYAMA, Kanagawa (JP); SEIJI SUZUKI, Kanagawa (JP)

(21) Appl. No.: 18/784,262

(22) Filed: Jul. 25, 2024

(30) Foreign Application Priority Data
Jul. 31, 2023 (JP) 2023-125131

(51) Int. Cl. B41J 2/175

(52) U.S. Cl. CPC B41J 2/175

(57) ABSTRACT

A liquid supply apparatus includes a tray that accommodates a liquid container with a supply port for supplying liquid to a liquid discharge head and a tray holding portion with a connection portion to be connected with the supply port that holds the tray. When the supply port is connected with the connection portion, the liquid can be supplied to the liquid discharge head, the tray is movable between a first position where the supply port of the liquid container accommodated in the tray and the connection portion are connected and a second position where the supply port of the liquid container accommodated in the tray and the connection portion are not connected. The tray rotates downward in a gravitational direction with respect to the tray holding portion when the tray slides and moves a predetermined distance or more in a first direction.

### BACKGROUND

### Field

The present disclosure relates to a liquid supply apparatus and a liquid discharge apparatus including the liquid supply apparatus.

### Description of the Related Art

There is known an ink jet recording apparatus as a liquid discharge apparatus that discharges ink onto a recording medium to record characters and images. Some of the ink jet recording apparatuses include an ink supply tank that stores ink to be supplied to a recording head, and a waste tank for collecting waste ink generated when a recovery operation of nozzles of the recording head is performed. Especially in a large liquid discharge apparatus such as a commercial printing machine, the ink tank and the waste tank are large in capacity and in weight.

In such a type of ink jet recording apparatus, there is known a configuration in which the replacement workability of the ink tank or the waste tank is improved by disposing the ink tank or the waste tank on a pull-out tray to allow a user to externally move the ink tank or the waste tank easily from within the ink jet recording apparatus. For example, Japanese Patent Application Laid-open No. 2023-018254 discusses a configuration in which an ink pack is accommodated in a tray with its upper surface open and that can be demounted by being pulled out from the liquid discharge apparatus.

However, with the configuration discussed in Japanese Patent Application Laid-open No. 2023-018254, in a case where the tray is disposed at a high position in the large liquid discharge apparatus, a user needs to perform a replacement work of the ink pack from below. In this case, it is difficult to visually recognize the ink pack from the top surface side of the tray. Thus, the workability when a user replaces the ink pack may sometimes be impaired.

### SUMMARY

The present disclosure is directed to a liquid supply apparatus with which workability when a liquid storage container is replaced is improved.

According to an aspect of the present disclosure, a liquid supply apparatus includes a tray configured to accommodate a liquid container provided with a supply port for supplying liquid to a liquid discharge head and a tray holding portion provided with a connection portion to be connected with the supply port and configured to hold the tray, wherein in a case where the supply port is connected with the connection portion, the liquid can be supplied to the liquid discharge head, wherein the tray is movable between a first position where the supply port of the liquid container accommodated in the tray and the connection portion are connected and a second position where the supply port of the liquid container accommodated in the tray and the connection portion are not connected, and wherein the tray rotates downward in a gravitational direction with respect to the tray holding portion when the tray slides and moves a predetermined distance or more in a first direction from the first position toward the second position.

Further features of the present disclosure will become apparent from the following description of exemplary embodiments with reference to the attached drawings.

### BRIEF DESCRIPTION OF THE DRAWINGS

FIG. 1 is a schematic cross-section diagram illustrating an internal configuration of a recording apparatus according to an exemplary embodiment.

FIG. 2 is a perspective diagram illustrating a configuration of a sheet conveyance unit frame according to the exemplary embodiment.

FIG. 3 is a perspective diagram illustrating a recording head lifting/lowering mechanism according to the exemplary embodiment.

FIG. 4 is a perspective diagram illustrating a liquid supply apparatus according to the exemplary embodiment.

FIGS. 5A and 5B are perspective diagrams respectively illustrating an ink tank and a tray according to a first exemplary embodiment.

FIGS. 6A and 6B are perspective diagrams illustrating a tray holding portion according to the first exemplary embodiment.

FIGS. 7A and 7B are diagrams illustrating a pull-out configuration of the liquid supply apparatus according to the first exemplary embodiment.

FIGS. 8A, 8B, 8C, and 8D are diagrams illustrating shifts in a pull-out operation of the tray according to the first exemplary embodiment.

FIGS. 9A and 9B are cross-section diagrams illustrating a configuration of a tray according to a second exemplary embodiment.

### DESCRIPTION OF THE EMBODIMENTS

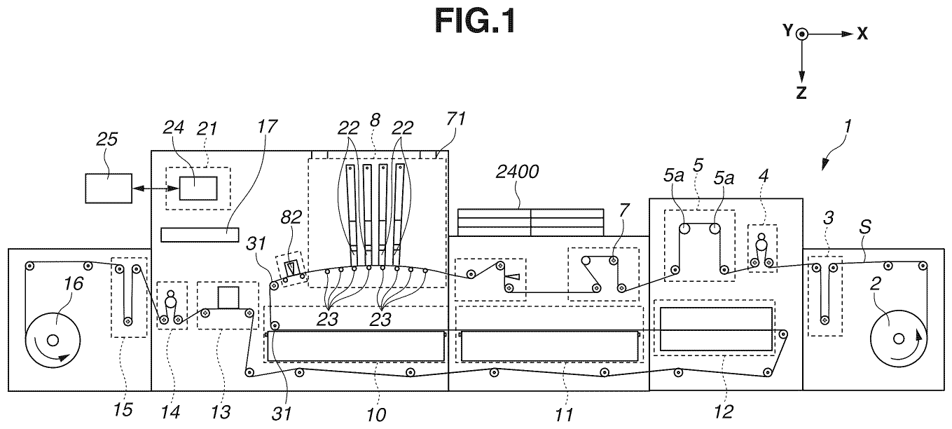

With reference to the attached drawings, a first exemplary embodiment will be described. FIG. 1 is a schematic cross-section diagram illustrating an internal configuration of a recording apparatus 1. The recording apparatus 1 according to the present exemplary embodiment includes an unwinding roll unit 2, a first dancer unit 3, a first main conveyance unit 4, a meandering correction unit 5, a mark detection unit 6, a tension detection unit 7, a recording unit 8, and a registration detection sensor 82. The recording apparatus 1 also includes a first drying unit 10, a second drying unit 11, a cooling unit 12, a second scanner unit 13, a second main conveyance unit 14, a second dancer unit 15, a winding roll unit 16, and a maintenance unit 17. A sheet S serving as a recording medium is conveyed along a sheet conveyance path illustrated in solid lines in FIG. 1, and processed by the units described above.

The unwinding roll unit 2 is a unit for holding and supplying a continuous sheet wound in a roll shape. The unwinding roll unit 2 stores an unwinding roll, and the sheet S is pulled out and supplied. The number of storable rolls is not limited to one, and two or more rolls can be stored, and the sheet S is selectively pulled out and supplied from one of the rolls.

The first dancer unit 3 is a unit for providing a predetermined sheet tension between the unwinding roll unit 2 and the first main conveyance unit 4. The sheet tension is provided by a tension provision unit (not illustrated) of the first dancer unit 3.

The first main conveyance unit 4 is a unit for feeding the sheet S to the meandering correction unit 5, the tension detection unit 7, the mark detection unit 6, the recording unit 8, the registration detection sensor 82, the first drying unit 10, the second drying unit 11, the cooling unit 12, and the second scanner unit 13, which are arranged along the sheet conveyance path in this order, and providing a sheet tension between the first main conveyance unit 4 and the second main conveyance unit 14. The first main conveyance unit 4 rotates driven by a motor (not illustrated), to convey the sheet S in a tensioned manner.

The meandering correction unit 5 is a unit for correcting the meandering of the sheet S in a sheet width direction when the sheet S is conveyed in a tensioned manner. The meandering correction unit 5 includes meandering correction rollers 5a and a meandering detection sensor (not illustrated) for detecting the meandering of the sheet S. The meandering correction rollers 5a can change their inclinations with respect to the sheet S each by a motor (not illustrated), to correct the meandering of the sheet S, based on the detection result of the meandering detection sensor. The function of correcting the meandering can be enhanced by the sheet S wound around the meandering correction rollers 5a.

The tension detection unit 7 is a unit for detecting a tension when the tensioned conveyance is performed between the first main conveyance unit 4 and the second main conveyance unit 14. The mark detection unit 6 is a unit for detecting a mark printed on the sheet S in advance to control an image forming timing of the recording unit 8.

The recording unit 8 is a sheet processing unit for forming an image by performing recording processing on the sheet S, by recording heads 22 serving as liquid discharge heads from above the conveyed sheet S. The conveyance path in the recording unit 8 is formed by guide rollers 23 arranged in an arc shape convex upward, and a clearance between the sheet S and the recording heads 22 is secured by a predetermined tension being applied to the sheet S. A plurality of recording heads serving as the recording heads 22 is arranged along a conveyance direction. In the present exemplary embodiment, the recording heads 22 are four color line type recording heads of black (Bk), yellow (Y), magenta (M), and cyan (C). The number of colors and the number of the recording heads 22 are not limited to four. The inkjet method can employ any method of using heater elements, piezoelectric elements, electrostatic elements, or microelectromechanical system (MEMS) elements. The ink is supplied to each of the recording heads 22 from a liquid supply apparatus 2400 via a corresponding ink tube. A configuration of the liquid supply apparatus 2400 will be described below.

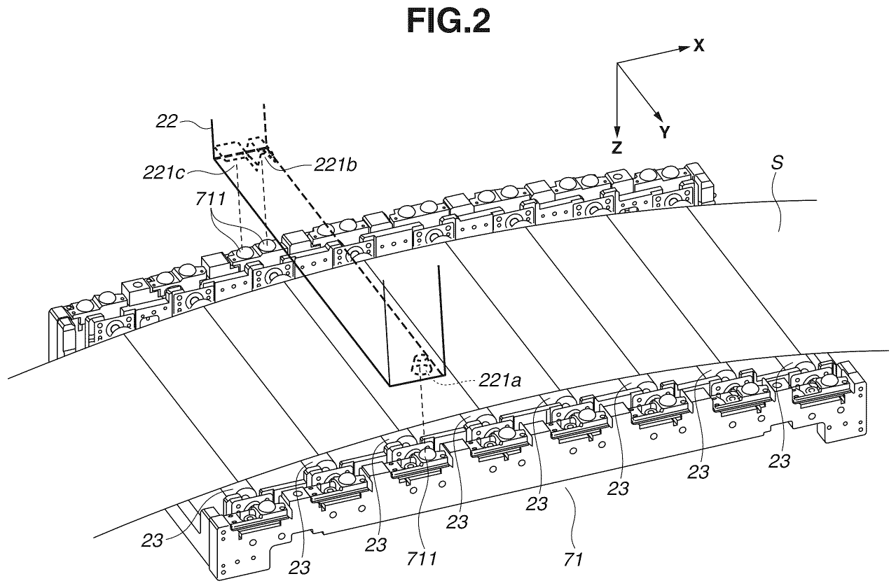

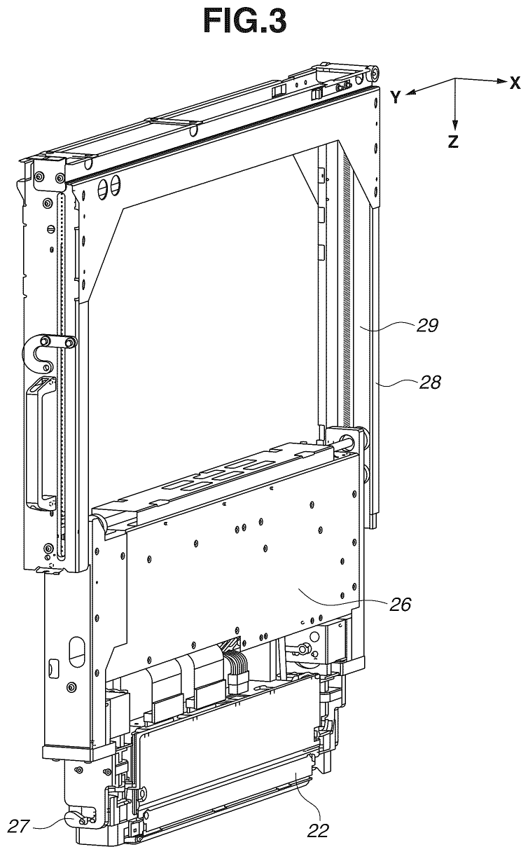

FIG. 2 is a perspective diagram illustrating a configuration of a sheet conveyance unit frame 71. The sheet conveyance unit frame 71 of the recording unit 8 is provided with a plurality of recording head positioning members 711 for positioning the recording heads 22, and for each of the recording heads 22, one recording head positioning member 711 is arranged on a front side, and two recording head positioning members 711 are arranged on a back side across the sheet S in the sheet width direction. As illustrated in FIG. 3, the recording head 22 is pivotally supported by a recording head holding unit 26 for holding, and lifting and lowering the recording head 22 in a manner to support a recording head supporting shaft 27 from below. The recording head holding unit 26 moves up and down along a lifting/lowering rail 29 provided in a recording head lifting/lowering frame 28 by a drive mechanism (not illustrated) provided in the recording head holding unit 26.

The first drying unit 10 and the second drying unit 11 are units for improving the fixability between the sheet S and ink by reducing the fluid component included in the ink applied by the recording unit 8 onto the sheet S. The second drying unit 11 is arranged downstream of the first drying unit 10 in the sheet conveyance direction. The first drying unit 10 and the second drying unit 11 heat the recorded sheet S to dry the applied ink. Inside the first drying unit 10 and the second drying unit 11, the ink-applied surface of the sheet S is dried by hot air blown at least from the ink-applied surface side of the sheet S to the sheet S passing through the first drying unit 10 and the second drying unit 11. In addition to the blowing of hot air, the drying method can be a method of irradiating the surface of the sheet S with an electromagnetic wave (e.g., ultraviolet light or infrared light), a method of conduction heat-transfer by contacting a heater, or a combination with the hot air blowing method.

Winding guide rollers 31 are rollers disposed downstream of the recording unit 8 in the conveyance direction for winding the opposite surface of the ink-applied surface of the sheet S at a predetermined contact angle because the transmission of the vibration due to the hot air blown from the first drying unit 10 to the recording unit 8 needs to be blocked. In the present exemplary embodiment, two winding guide rollers 31 are arranged between the registration detection sensor 82 and the first drying unit 10, and the sheet S is folded back at upper and lower positions of the apparatus in substantially parallel. The first drying unit 10 is arranged below the recording unit 8, and the second drying unit 11 is arranged below the above-described mark detection unit 6.

The cooling unit 12 cools the sheet S fixed by the first drying unit 10 and the second drying unit 11 to solidify the softened ink, and reduces an amount of temperature change of the sheet S in the downstream process by the recording apparatus 1. In the cooling unit 12, air cooler than the sheet S is blown from at least the ink-applied surface side to the sheet S passing through the inside of the cooling unit 12 to cool down the ink-applied surface of the sheet S. In order to increase the cooling efficiency, both surfaces of the sheet S can be cooled by applying air. The cooling method is not limited to the method of blowing air, and the cooling method can be a conduction heat-transfer method by contacting a heat dissipation member, or a combination with the method of blowing air.

The second main conveyance unit 14 is a unit for conveying the sheet S while applying a tension to the first main conveyance unit 4 and the sheet S to adjust the tension of the sheet S. The second main conveyance unit 14 rotates by being driven by a motor (not illustrated), and a tension control unit (not illustrated) adjusts the tension of the sheet S by a clutch (not illustrated) that can control the drive-coupled torque, based on a tension value detected by the tension detection unit 7. As an additional configuration for adjusting the tension of the sheet S, the tension detection unit 7 can control the speed of the second main conveyance unit 14. In this case, as a tension control method, the second main conveyance unit 14 has two methods, i.e., a torque control method of controlling a torque value transmitted from the clutch, and a speed control method of controlling the roller speed of the second main conveyance unit 14, and can switch the tension control methods or can use both of the methods together.

The second dancer unit 15 is a unit for providing a predetermined sheet tension between the second main conveyance unit 14 and the winding roll unit 16. The sheet tension is provided by a tension provision unit (not illustrated) of the second dancer unit 15.

The winding roll unit 16 is a unit for winding the sheet S having been subjected to the recording processing around a winding core. The number of collectable rolls is not limited to one, and the winding roll unit 16 can include two or more winding cores and selectively switch the winding cores to collect the sheet S. The winding roll unit 16 can be configured to cut the continuous sheet S using a cutter and stack the cut sheet S without winding the sheet S around the winding core depending on the processing content after the recording.

A control unit 21 is a unit for controlling the units in the entire recording apparatus 1. The control unit 21 includes a central processing unit (CPU), a storage device, a controller provided with various kinds of control units, an external interface, and an operation unit 24 for a user to perform input and output. The operation of the recording apparatus 1 is controlled based on instructions from the controller or a host apparatus 25 such as a host computer connected to the controller via the external interface.

The maintenance unit 17 is a unit including a mechanism for recovering the discharge performance of the recording heads 22. Examples of such a mechanism include a cap mechanism for protecting ink discharge surfaces of the recording heads 22, a wiper mechanism for wiping the ink discharge surfaces, and a suction mechanism for suctioning the ink in the recording heads 22 from the ink discharge surfaces using negative pressure. The maintenance unit 17 includes a drive mechanism (not illustrated) and a rail (not illustrated), and can reciprocally move along the rail in the horizontal direction. The maintenance unit 17 moves to immediately below the recording heads 22 when the maintenance of the recording heads 22 is performed, and moves to a position retracted from immediately below the recording heads 22 when the maintenance operation is not performed.

### Liquid Supply Apparatus

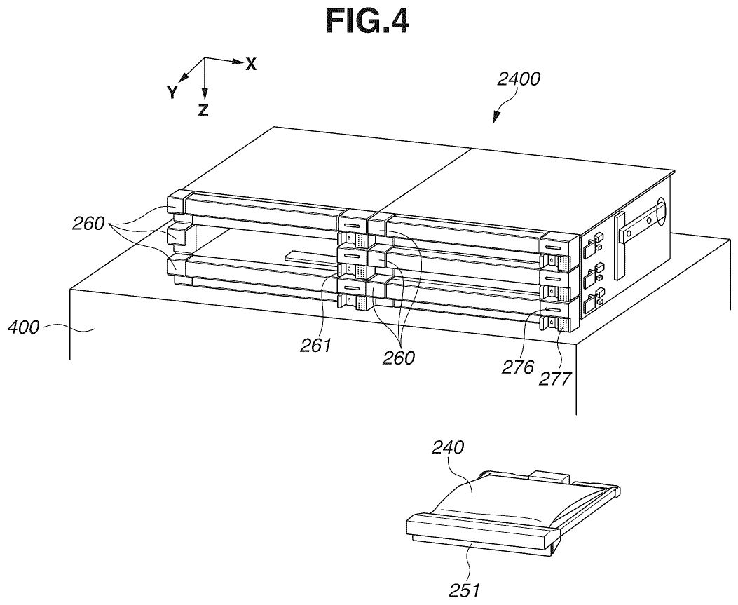

FIG. 4 is a perspective diagram of the liquid supply apparatus 2400. While the liquid supply apparatus 2400 is typically entirely enclosed by a housing or the like, for description purposes, FIG. 4 illustrates the liquid supply apparatus 2400 in a state where a part of the housing is removed so that the internal configuration of the liquid supply apparatus 2400 can be seen. FIG. 4 illustrates a state where one of trays 251 is pulled out so that relationships each between the tray 251 and a tray holding portion 260 can be seen.

The liquid supply apparatus 2400 includes a plurality of tray holding portions 260, and an ink tank 240 described below, which is a liquid container containing liquid such as ink, is set to each of the tray holding portions 260. A flow path 281 (not illustrated) formed of a flexible tube is connected to each of the ink tanks 240, to be connected to an ink buffer tank (not illustrated) of the recording apparatus 1 from the back surface side (−Y direction side) of the liquid supply apparatus 2400. From the ink buffer tank, a flow path formed of a tube is connected to a flow path in the recording apparatus 1 to be connected to each of the recording heads 22. The results in formation of the flow paths from the ink tanks 240 to the ink buffer tanks and the recording heads 22, and inks in the ink tanks 240 are supplied to the recording heads 22 via the flow paths, respectively.

A tank state informing unit 276 and a color label 277 are arranged on a +X side of the liquid supply apparatus 2400. The tank state informing unit 276 includes light-emitting diodes (LEDs) of two different colors, and is provided on each stage. Each of the LEDs of two colors can be turned on and off. With the combinations thereof, a user can be informed of the state of the ink tank 240 of each stage. With the color label 277, a user can visually recognize to which stage each of the ink tanks 240 is to be set, and it is possible to prevent the erroneous mounting of the ink tanks 240.

### Configuration of Tray and Ink Tank

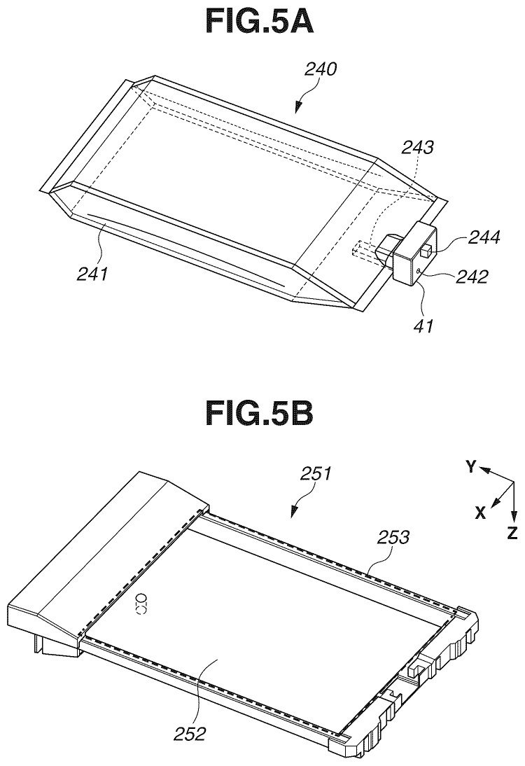

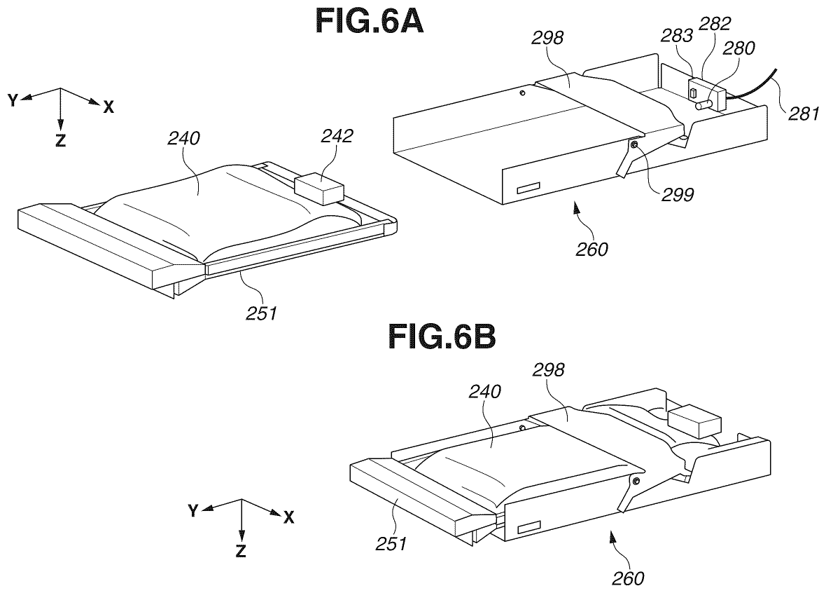

FIGS. 5A and 5B are perspective diagrams illustrating the ink tank 240 and the tray 251, respectively. FIGS. 6A and 6B are perspective diagrams illustrating only one of the tray holding portions 260 for one stage, for descriptive purposes. The tray 251 can support the ink tank 240 by a tank reception portion 252 and set the ink tank 240 in the tray holding portion 260. The tank reception portion 252 includes an opening portion 253 opening upward in a gravitational direction in a state where the tank reception portion 252 is set in the tray holding portion 260, and the ink tank 240 is accommodated in the tank reception portion 252 via the opening portion 253.

As illustrated in FIG. 5A, the ink tank 240 according to the present exemplary embodiment has a bag-like shape, and each side of the ink tank 240 is formed of a flexible member. On both sides of the ink tank 240 in the width direction (X direction), gusset portions 241 folded inside are provided to increase an amount of liquid containable in the ink tank 240. The bag-like shape ink tank 240 is formed by welding these gusset portions 241 to the ink tank 240. When the amount of liquid inside the ink tank 240 is large, the gusset portions 241 expand. When the amount of liquid inside the ink tank 240 is small, the gusset portion 241 is folded. In this way, the shape of the ink tank 240 changes depending on the amount of ink. In general, the ink tank 240 is formed of a material having a structure composed of a plurality of layers such as polyethylene terephthalate (PET). However, in a case where the liquid contained in the ink tank 240 has a property of reacting with air and solidifying, or the density or the remaining amount of the liquid can change by evaporation, the flexible members are each formed to have a layer structure including an aluminum layer to reduce the change in property of the ink.

A supply port 242 is provided on one side of the ink tank 240, and is connected to an intake port 243 in the ink tank 240. In the supply port 242, a spring biased type valve (not illustrated) is provided. The valve is opened by inserting an ink supply needle 280, which is a connection portion provided in an ink supply needle holder 282 illustrated in FIG. 6A,. A liquid reservoir of the ink tank 240 and the flow path 281 located downstream thereof are connected to enable the liquid to be supplied to the liquid supply apparatus 2400.

### Mounting Ink Tank on Tray

The ink tank 240 is set on the tank reception portion 252 of the tray 251 (FIG. 6A), and the tray 251 is inserted into the tray holding portion 260 (FIG. 6B) to be an ink tank set state. When the tray 251 turns into the ink tank set state, a tank substrate 244 including a contact portion provided near the supply port 242 and a connector 283 provided on the ink supply needle holder 282 are brought into contact to enable an electrical connection. With the electrical connection, it is possible to read individual information about the mounted ink tank 240, such as whether the mounted ink tank 240 is new or used once and remounted, an ink remaining amount, and color information about the stored ink. By reading the individual information, the recording apparatus 1 can determine whether the ink tank 240 set on the tray 251 is suitable. For example, it is possible to notify a user in a case where the color of the ink contained in the set ink tank 240 is different from the color that should be set on the tray 251. It can be possible to notify the user in a case where an ink remaining amount stored in the set ink tank 240 is less than an ink amount lower limit (predetermined amount) determined in advance. The notification can be performed by a method such as an LED lighting display, a sound, a vibration, or displaying an image through an external apparatus or a display by the tank state informing unit 276.

### Mounting Tray on Holding Portion

When the tray 251 is inserted into the tray holding portion 260 to be the set state, the tank substrate 244 and the connector 283 provided on the ink supply needle holder 282 are brought into contact and electrically connected.

The recording apparatus 1 reads information about the tank substrate 244 to determine whether the mounted ink tank 240 is not in use. In a case where the recording apparatus 1 determines that the ink tank 240 is not in use or in use but the ink remaining amount is more than the predetermined amount, the recording apparatus 1 display a user guide screen on an operation unit (not illustrated) to notify a user that the ink tank 240 is in a set state. In a case where the ink remaining amount of the mounted ink tank 240 is less than the predetermined amount, the guide screen for the user is kept in the state of prompting the user to replace the ink tank 240 with a new one.

### Pull-out Configuration of Liquid Supply Apparatus

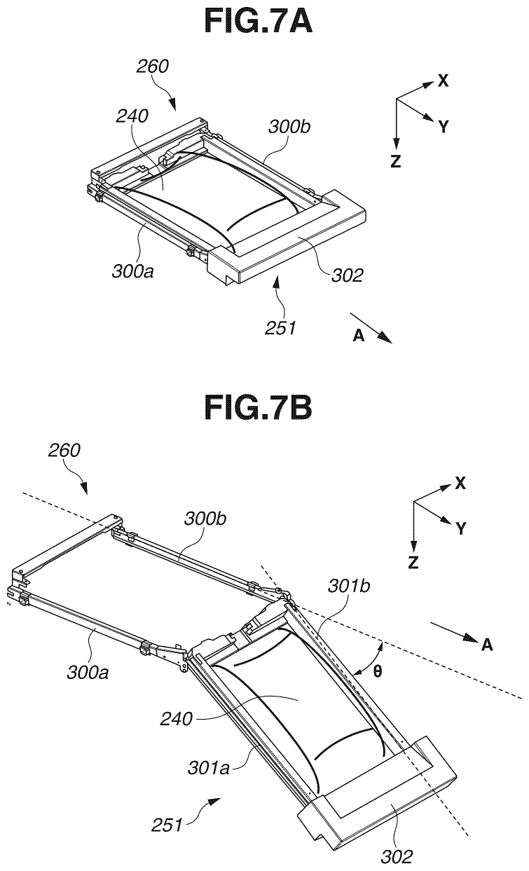

With reference to FIGS. 7A and 7B, a pull-out configuration of the liquid supply apparatus 2400 will be described. FIG. 7A is a perspective diagram illustrating a state where the tray 251 is set in the tray holding portion 260 and FIG. 7B is a perspective diagram illustrating a state where the tray 251 is pulled out. When the ink tank 240 is replaced, a user shifts the state of the tray 251 from a set state illustrated in FIG. 7A, to a pull-out state illustrated in FIG. 7B by gripping and pulling out a gripping portion 302 in a +Y direction.

The tray holding portion 260 includes fixed-side guides 300a and 300b. The tray 251 includes movable-side guides 301a and 301b. The tray 251 can be slid in the +Y direction to be pulled out from the tray holding portion 260 by the movable-side guides 301a and 301b moving respectively guided by the fixed-side guides 300a and 300b. In this way, the tray 251 is movable in the Y direction with respect to the tray holding portion 260, and movable between a position at which the above-described supply port 242 and the ink supply needle 280 are connected and a position at which the supply port 242 and the ink supply needle 280 are not connected.

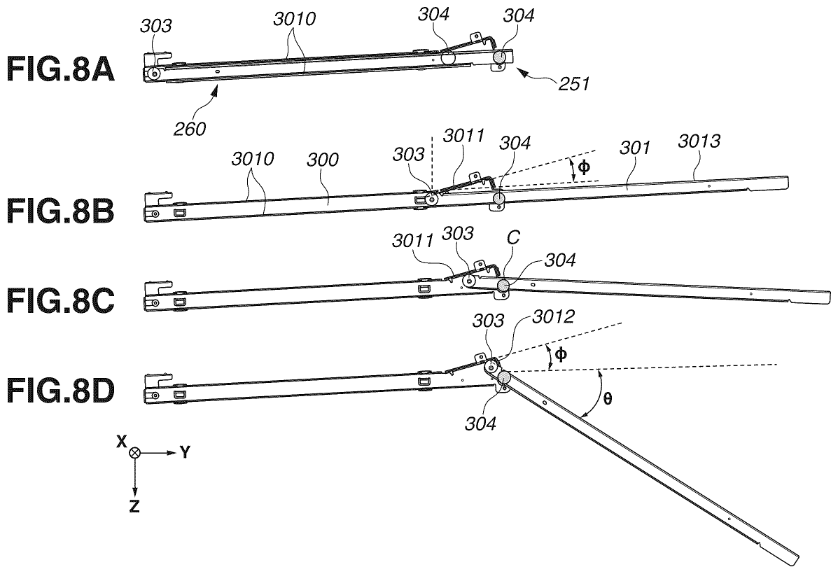

The moving operation of the tray 251 shifting from the state where the tray 251 is set in the tray holding portion 260 to the state where the tray 251 is pulled out from the tray holding portion 260 will now be described. FIGS. 8A, 8B, 8C, and 8D are cross-section diagrams illustrating a mechanism around the guides for shifting from the state where the tray 251 is set in the tray holding portion 260 to the state where the tray 251 is pulled out from the tray holding portion 260.

FIG. 8A illustrates the state where the tray 251 is set in the tray holding portion 260, and FIG. 8B illustrates a state where the tray 251 is pulled out halfway. FIG. 8C illustrates a state where the tray 251 starts rotating after the tray 251 is pulled out halfway, and FIG. 8D illustrates a state where the tray 251 is completely pulled out (replacement work time state).

The operation of shifting from the state in FIG. 8A to the state in FIG. 8B will be described. The tray holding portion 260 includes a fixed-side roller 304, and the fixed-side roller 304 contacts fixed-side roller receiving portions 3010 formed on a fixed-side guide 300 included in the pullout tray 251, and rotates. The tray 251 includes a movable-side roller 303 arranged upstream of the fixed-side roller 304 in the Y direction, and the movable-side roller 303 contacts a movable-side roller receiving portion 3013 formed on a movable-side guide 301 included in the tray holding portion 260, and rotates. The fixed-side roller 304 and the movable-side roller 303 contact and rotate to move the tray 251 in the +Y direction. In this way, the state in FIG. 8A shifts to the state in FIG. 8B.

Next, an operation of shifting from the state in FIG. 8B to the state in FIG. 8C will be described. On the fixed-side guide 300, a fixed-side roller receiving slope portion 3011 with a slope of a predetermined angle Φ with respect to the fixed-side roller receiving portions 3010 is formed. As the tray 251 is being pulled out in the +Y direction from the state in FIG. 8B, the movable-side roller 303 runs off the contact area with the fixed-side roller receiving portions 3010, and comes into contact with the fixed-side roller receiving slope portion 3011 illustrated in FIG. 8C.

At this time, the movable-side guide 301 included in the tray 251 is in contact with the fixed-side roller 304, and a contact point C functions as a rotational fulcrum (rotation center) of the tray 251. Because the center of gravity of the tray 251 is located on the +X side of the rotational fulcrum (i.e., contact point C), the tray 251 rotates clockwise with the contact point C as the fulcrum up to a position at which the movable-side roller 303 is brought into contact with the fixed-side roller receiving slope portion 3011.

Next, an operation of shifting from the state in FIG. 8C to the state in FIG. 8D will be described. A pull-out prevention portion 3012 serving as a position restriction portion for the movable-side roller 303 is provided at an end portion in the +Y direction of the fixed-side roller receiving slope portion 3011 of the fixed side guide 300. When the tray 251 is pulled out in the +Y direction from the state in FIG. 8C, the movable-side roller 303 contacts the pull-out prevention portion 3012, and the movement of the tray 251 in the +Y direction is restricted. In this way, the movement of the tray 251 in the pull-out direction is restricted, and the state of the tray 251 becomes as illustrated in FIG. 8D. Because the fixed-side roller receiving slope portion 3011 is the slope inclining at the angle Φ, the movable-side roller 303 moves upward in the gravitational direction (−Z direction), the tray 251 further rotates largely with respect to the state in FIG. 8C, and stops at a position further rotated by an angle θ. At this time, the tray 251 is in a posture in which the gripping portion 302 is located below the tray holding portion 260 downward in the gravitational direction (+Z direction).

As described above, in the present exemplary embodiment, when the tray 251 slides and moves more than the predetermined distance in the +Y direction, the tray 251 can rotate clockwise. In this way, because the pulled out tray 251 inclines and the opening portion 253 turns to the user side, the user can visually recognize inside the tray 251 easily, and the workability when the ink tank 240 is replaced is improved.

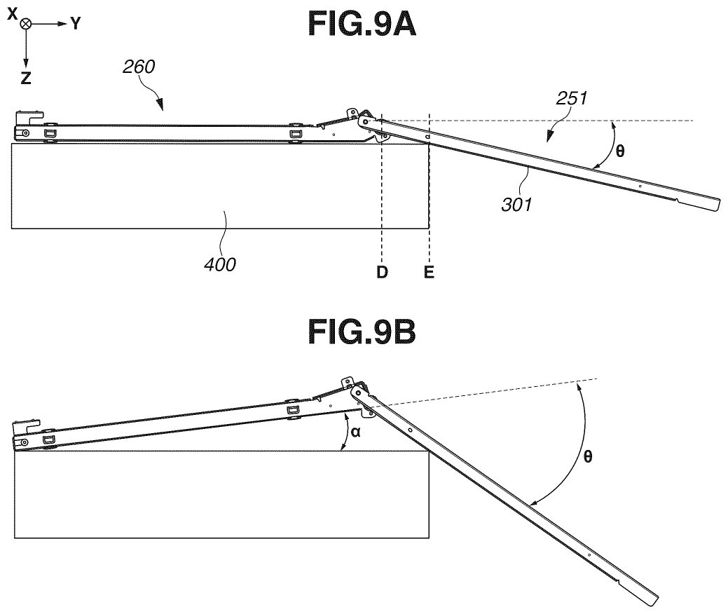

With reference to FIGS. 9A and 9B, a second exemplary embodiment will be described. Descriptions of configurations similar to those in the first exemplary embodiment are omitted.

As illustrated in FIG. 9A, the tray holding portion 260 according to the present exemplary embodiment is arranged on an upper side of an apparatus 400 as an installation surface. In a case where a side surface E in the +Y direction of the apparatus 400 is located on the +Y side of a position D of the rotational fulcrum of the tray 251, the movable-side guide 301 included in the tray 251 is brought into contact with the upper surface of the apparatus 400 when the tray 251 is rotated. When the movable-side guide 301 is brought into contact with the upper surface of the apparatus 400, the rotation of the tray 251 is restricted and cannot further rotate (cannot move in a direction of increasing the angle θ). In a case where the rotation angle θ is small, because the degree of the opening portion 253 of the tray 251 turning in the +Y direction becomes small, and in particular, in a case where the tray 251 is arranged at a high position in the gravitational direction, a user may not visually recognize sufficiently inside the tray 251. In the present exemplary embodiment, a configuration in which the rotation angle θ can become enough large in the case described above will be described.

In the present exemplary embodiment, as illustrated in FIG. 9B, the tray holding portion 260 is arranged to incline by an angle a with respect to the apparatus 400. With this configuration, because a space can be secured between the tray holding portion 260 and the upper surface of the apparatus 400, the rotation angle θ until the tray 251 rotates and the movable-side guide 301 is brought into contact with the upper surface of the apparatus 400 can be made larger than the rotation angle θ in FIG. 9A.

With the above-described configuration, because the pulled out tray 251 inclines and the opening portion 253 turns to the user side, the user can visually recognize inside the tray 251 easily, and the workability when the ink tank 240 is replaced is improved.

According to the present disclosure, it is possible to improve the workability when the liquid container is replaced.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-125131, filed Jul. 31, 2023, which is hereby incorporated by reference herein in its entirety.

What is claimed is:

1. A liquid supply apparatus comprising:
a tray configured to accommodate a liquid container provided with a supply port for supplying liquid to a liquid discharge head; and
a tray holding portion provided with a connection portion to be connected with the supply port and configured to hold the tray,
wherein in a case where the supply port is connected with the connection portion, the liquid can be supplied to the liquid discharge head,
wherein the tray is movable between a first position where the supply port of the liquid container accommodated in the tray and the connection portion are connected and a second position where the supply port of the liquid container accommodated in the tray and the connection portion are not connected, and
wherein the tray rotates downward in a gravitational direction with respect to the tray holding portion when the tray slides and moves a predetermined distance or more in a first direction from the first position toward the second position.

2. The liquid supply apparatus according to claim 1,
wherein the liquid container is accommodated in the tray via an opening portion of the tray, and
wherein in a case where the tray rotates with respect to the tray holding portion, the tray inclines so that the opening portion turns to the first direction.

3. The liquid supply apparatus according to claim 1,
wherein the tray includes a gripping portion, and
wherein in a case where the tray rotates with respect to the tray holding portion, the gripping portion is located below the tray holding portion in the gravitational direction.

4. The liquid supply apparatus according to claim 1,
wherein the tray slides and moves in the first direction via a first roller, and wherein the tray rotates with a point of the tray contacting the first roller as a rotation center.

5. The liquid supply apparatus according to claim 4,
wherein the tray includes a second roller arranged upstream of the first roller in the first direction, and
wherein in a case where the tray rotates, a position of the second roller moves upward in the gravitational direction.

6. The liquid supply apparatus according to claim 5, wherein the tray holding portion includes a restriction portion configured to, in a case where the tray rotates, restrict the second roller from moving in the first direction.

7. The liquid supply apparatus according to claim 1, wherein the tray holding portion inclines so that the rotation center is further from an installation surface of the liquid supply apparatus than the connection portion.

8. A liquid discharge apparatus comprising:
a liquid discharge head configured to discharge the liquid onto a recording medium;
a conveyance unit configured to convey the recording medium; and
.a liquid supply apparatus, wherein the liquid supply apparatus comprises:
a tray configured to accommodate a liquid container provided with a supply port for supplying liquid to a liquid discharge head; and
a tray holding portion provided with a connection portion to be connected with the supply port and configured to hold the tray,
wherein in a case where the supply port is connected with the connection portion, the liquid can be supplied to the liquid discharge head,
wherein the tray is movable between a first position where the supply port of the liquid container accommodated in the tray and the connection portion are connected and a second position where the supply port of the liquid container accommodated in the tray and the connection portion are not connected, and
wherein the tray rotates downward in a gravitational direction with respect to the tray holding portion when the tray slides and moves a predetermined distance or more in a first direction from the first position toward the second position.
